(19) United States
(12) Patent Application Publication
(10) Pub. No.: US 2024/0173830 A1
(43) Pub. Date: May 30, 2024

(54) CIRCLIP PLIERS WITH IMPROVED DESIGN

(71) Applicant: Apex Brands, Inc., Apex, NC (US)

(72) Inventors: Jesse Higgins, Raleigh, NC (US); Eric Van Fossen, Huntersville, NC (US); Zhihong Fu, Cary, NC (US); Kyle Romanick, Fuquay Varina, NC (US); Miles Cawley, Charlotte, NC (US)

(21) Appl. No.: 18/502,199

(22) Filed: Nov. 6, 2023

Related U.S. Application Data
(60) Provisional application No. 63/428,839, filed on Nov. 30, 2022.

(51) Int. Cl. B25B 27/20

(52) U.S. Cl. CPC B25B 27/205

(57) ABSTRACT

A hand tool includes a head section which may include a top jaw and a bottom jaw, a handle section which may include a top handle and a bottom handle, a joint assembly which may operably couple the head section to the handle section, and a pin assembly which may include a first pin disposed at a distal end of the top jaw and a second pin disposed at a distal end of the bottom jaw. A high friction surface may be disposed over at least a portion of the first and second pins.

### CROSS REFERENCE TO RELATED APPLICATION

This application claims priority to U.S. provisional application No. 63/428,839 filed Nov. 30, 2022, the entire contents of which are incorporated herein by reference.

### TECHNICAL FIELD

Example embodiments generally relate to hand tools and, in particular, relate to solid circlip pliers that are provided with improved circlip coupling members.

### BACKGROUND

Hand tools are commonly used across all aspects of industry and in the homes of consumers. Hand tools are employed for multiple applications including, for example, tightening, component joining and/or the like. For some component joining applications, a solid joint pliers (e.g., a pliers that does not have a slip joint, tongue-and-groove, channel lock, or other adjustable joint) may be preferred. In some cases, solid joint pliers may be adapted for specific use with circlips in applications where other components are required to be retained on shafts or housings of various types. In this regard, pliers may be used to either contract or expand circlips to depending on whether the circlip is externally applied or internally applied.

Often referred to as circlip pliers, retaining ring pliers, or snap ring pliers, typical circlip pliers operably couple to a circlip to allow for the pliers to either expand or contract the circlip in order to effectively apply the circlip in a desired position. Many circlips are formed as open ended rings, rather than being one continuous and intact circle. Proximate to the open end, some circlips may include an orifice disposed on either side of the open end to which the circlip pliers may operably couple. Thus, using the open end, the circlip may rely on spring tension to retain their natural shape, and in order to apply a force to either expand or contract the circlip, the circlip pliers may operably couple to the orifices. However, in some cases, the circlip pliers can be difficult to operably couple to the circlip, or the circlip may be difficult to keep operably coupled with the circlip pliers.

Thus, it may be desirable to develop an improved design for circlip pliers.

### BRIEF SUMMARY OF SOME EXAMPLES

Some example embodiments may provide for a hand tool. The hand tool may include a head section which may include a top jaw and a bottom jaw, a handle section which may include a top handle and a bottom handle, a joint assembly which may operably couple the head section to the handle section, and a pin assembly which may include a first pin disposed at a distal end of the top jaw and a second pin disposed at a distal end of the bottom jaw. A high friction surface may be disposed over at least a portion of the first and second pins.

Some other example embodiments may provide for a pin assembly for a hand tool. The pin assembly may include a first pin disposed at a distal end of a top jaw of the hand tool and a second pin disposed at a distal end of a bottom jaw of the hand tool. A high friction surface may be disposed over at least a portion of the first and second pins.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1A illustrates a perspective view of a hand tool according to an example embodiment;

FIG. 1B illustrates a perspective view of a hand tool according to an example embodiment;

FIG. 2 is a close up view of the head portion of the hand tool in accordance with an example embodiment;

FIG. 3 illustrates a diagram of a laser etching process in accordance with an example embodiment;

FIG. 4 is a close up view of the head portion of the hand tool in accordance with an example embodiment;

FIG. 5 is a close up view of the head portion of the hand tool in accordance with an example embodiment;

FIG. 6 is a close up view of the head portion of the hand tool in accordance with an example embodiment;

FIG. 7 is a close up view of the head portion of the hand tool in accordance with an example embodiment;

FIG. 8 is a close up view of the head portion of the hand tool in accordance with an example embodiment; and

FIG. 9 is a close up view of the head portion of the hand tool in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

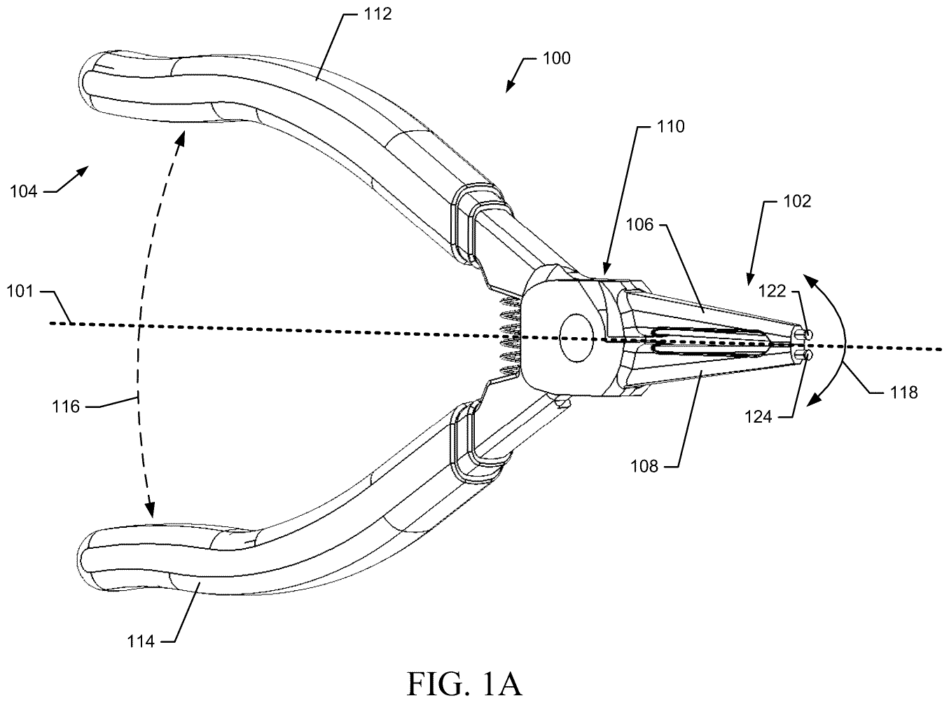

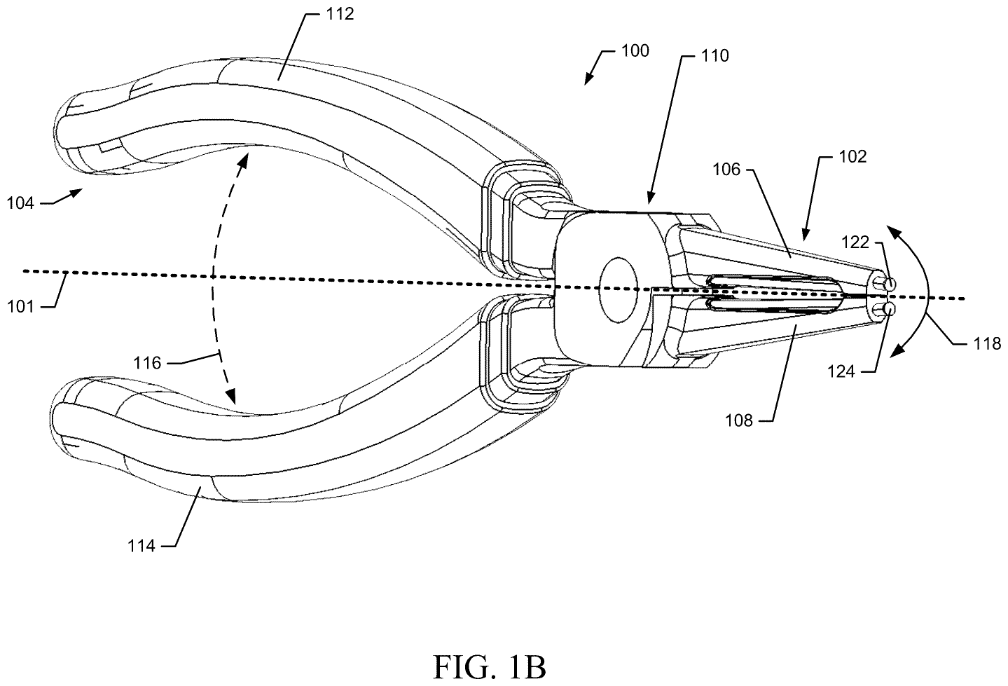

As indicated above, some example embodiments may relate to the provision of circlip pliers that employ an improved design. Of note, the hand tool 100 of FIGS. 1A and 1B should be understood to be positioned such that it can be bisected by a vertically oriented plane that passes through the longitudinal centerline 101 of the hand tool 100. The terms “top,” “bottom,” “right,” and “left” should therefore be understood as relative terms that are applicable to this particular orientation. To the extent the terms “front” and “back” are also used, the front of the hand tool 100 should be understood to be the working end thereof (i.e., the end at which the jaws are located), and the back of the hand tool 100 is the opposite end to the working end (i.e., the end at which the handles are located).

Referring now to FIGS. 1A and 1B, the hand tool 100 may include a head section 102 and a handle section 104. The head section 102 may include a top jaw 106 and a bottom jaw 108. The head section 102 may be separated from the handle section 104 by the joint assembly 110. The handle section 104 may include a top handle 112 and a bottom handle 114. A pin assembly 120 may be disposed at a distal end of the head section 102 at the front of the hand tool 100. In this regard, the top jaw 106 and the bottom jaw 108 may each include a bore disposed at the distal end of each jaw (106, 108) that extends into the respective jaw towards the joint assembly 110, substantially parallel to the longitudinal centerline 101 of the hand tool 100 when the hand tool 100 is in the state depicted in FIG. 1A with the top and bottom jaws (106, 108) proximate to one another. In some cases, the top jaw 106 may include a top planar surface 107 and the bottom jaw 108 may include a bottom planar surface 109. The top and bottom planar surfaces (107, 109) may be formed so that when the top jaw 106 is proximate to the bottom jaw 108, the top planar surface 107 may be in contact with the bottom planar surface 109 such that a contact plane is formed between them that includes the longitudinal centerline 101. In some cases, each planar surface (107, 109) may extend a length substantially equal to the depth of the bore in each of the top and bottom jaws (106, 108).

The pin assembly 120 may include a first pin 122 disposed in the bore of the top jaw 106, and a second pin 124 disposed in the bore of the bottom jaw 108. The first and second pins (122, 124) of the pin assembly 120 may extend out of their respective bores, away from their respective jaws in which the first and second pins (122, 124) are disposed. In this regard, the hand tool 100 may operably couple to a circlip and thus may apply a force to the circlip to either expand or contract the circlip to fit in a desired location via the pin assembly 120. As such, in some cases, the circlip may include first and second orifices that may correspond to the first and second pins (122, 124) of the pin assembly 120. Responsive to the first and second pins (122, 124) operably coupling to the first and second orifices, the hand tool 100 may be used to apply a force to the circlip to either expand or contract the circlip to fit the circlip in the desired location.

FIG. 1A depicts an embodiment where the hand tool 100 may be a set of external circlip pliers. In this embodiment, the top jaw 106 and top handle 112 may be formed of a rigid metallic material (e.g., iron or steel, such as induction hardened steel) and the bottom jaw 108 and bottom handle 114 may be similarly formed of a rigid metallic material (e.g., the same material used to form the top jaw 106 and top handle 112). The single unitary piece comprising the top jaw 106 and top handle 112 may transition between the top jaw 106 and the top handle 112 at a transition portion that is located at the joint assembly 110. Likewise, the single unitary piece comprising the bottom jaw 108 and bottom handle 114 may similarly transition between the bottom jaw 108 and the bottom handle 114 at a transition portion that is located at the joint assembly 110. In this regard, the joint assembly 110 may be where the two unitary pieces (top and bottom) of the hand tool 100 are pivotably operably coupled to each other. In an example embodiment, at least some of the metallic portions of the hand tool 100 may be covered with a corrosion resistant finish (e.g., a black-oxide finish). Lengths of the top jaw 106 and top handle 112 and of the bottom jaw 108 and the bottom handle 114 may be selected to provide any desirable length for the hand tool 100.

As mentioned above, the external circlip pliers depicted in FIG. 1A may expand the circlip in order to place the circlip in the desired location. In some embodiments, for example, an external circlip may be used to hold objects in place on a shaft, and as such, the circlip may need to be expanded to fit around the shaft and then released thereafter to secure the circlip to the exterior of the shaft. In this regard, the external circlip may rely on a spring force to operably couple to the desired location, such as on the exterior of the shaft. Thus, in a pair of external circlip pliers, compressing the top handle 112 toward the bottom handle 114 (i.e., by moving them in the direction opposite the direction shown by arrow 116) may pivot the top jaw 106 away from the bottom jaw 108 (i.e., in the direction shown by arrow 118), which thereby moves the first pin 122 away from the second pin 124 and may apply a force on the circlip to expand the external circlip to be placed in the desired location.

FIG. 1B depicts an embodiment where the hand tool 100 may be a set of internal circlip pliers. In this embodiment, the top jaw 106 and bottom handle 114 may be formed of a rigid metallic material (e.g., iron or steel, such as induction hardened steel) and the bottom jaw 108 and top handle 112 may be similarly formed of a rigid metallic material (e.g., the same material used to form the top jaw 106 and bottom handle 114). The single unitary piece comprising the top jaw 106 and bottom handle 114 may transition between the top jaw 106 and the bottom handle 114 at a transition portion that is located at the joint assembly 110. Likewise, the single unitary piece comprising the bottom jaw 108 and top handle 112 may similarly transition between the bottom jaw 108 and the top handle 112 at a transition portion that is located at the joint assembly 110. In this regard, the joint assembly 110 may be where the two unitary pieces of the hand tool 100 are pivotably operably coupled to each other. In an example embodiment, at least some of the metallic portions of the hand tool 100 may be covered with a corrosion resistant finish (e.g., a black-oxide finish). Lengths of the top jaw 106 and top handle 112 and of the bottom jaw 108 and the bottom handle 114 may be selected to provide any desirable length for the hand tool 100.

In comparison to the external circlip pliers described above, the internal circlip pliers depicted in FIG. 1B may contract the circlip in order to place the circlip in the desired location. In some embodiments, for example, an internal circlip may be used to hold objects in place inside a tube, and as such, the internal circlip may need to be contracted to fit inside the tube and then released to secure to the interior of the tube. In this regard, the internal circlip may rely on a spring force to operably couple to the desired location, such as on the interior of the tube. Thus, in a pair of internal circlip pliers, separating the top handle 112 from the bottom handle 114 (i.e., by moving them in the direction shown by arrow 116) may pivot the top jaw 106 away from the bottom jaw 108 (i.e., in the direction shown by arrow 118), which thereby moves the first pin 122 away from the second pin 124. Then, responsive to the top handle 112 being compressed back towards the bottom handle 114, the opposite motions may occur, and the first pin 122 may move back towards the second pin 124. Accordingly, the internal circlip pliers may apply a force on the circlip to contract the internal circlip to be placed in the desired location responsive to the top handle 112 being compressed back towards the bottom handle 114.

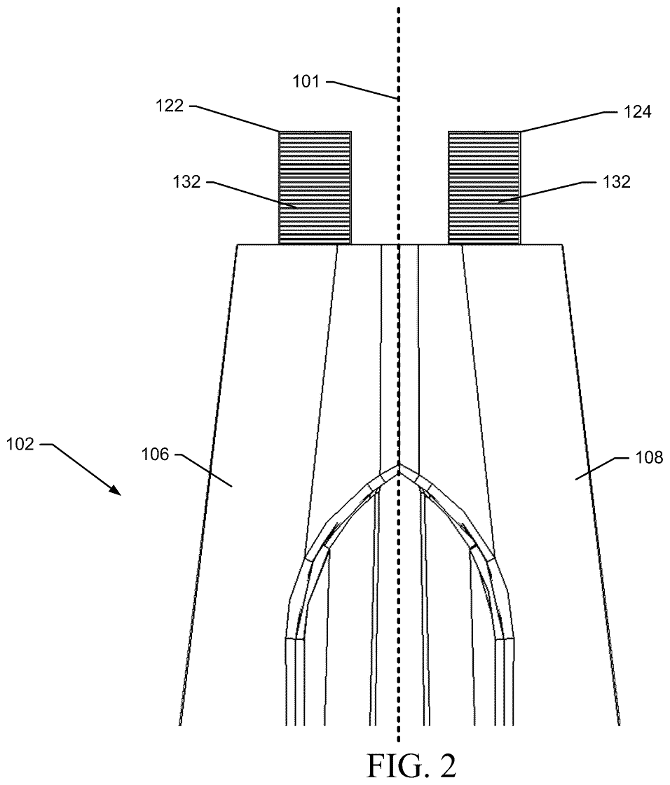

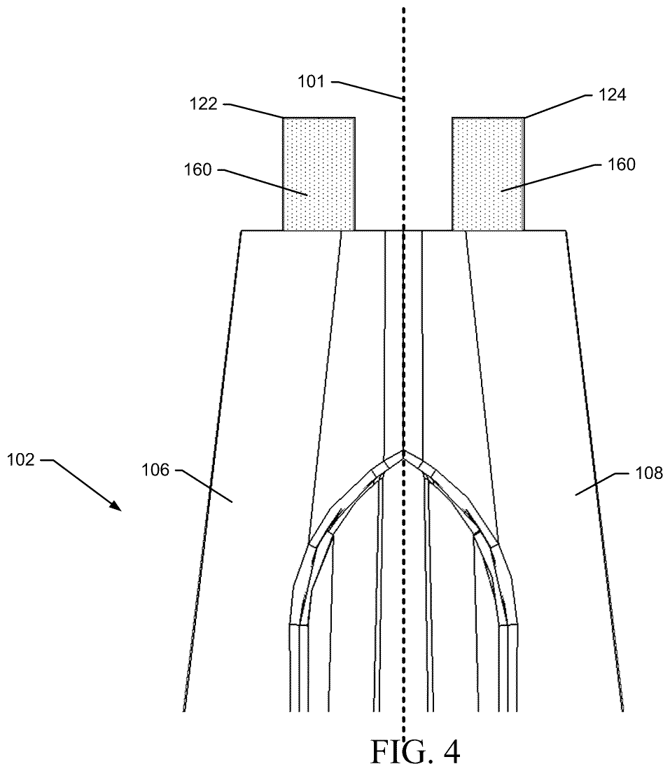

FIGS. 2-9 depict various embodiments of the pin assembly 120 of the hand tool 100. In this regard, the pin assembly 120 may include various features that may improve the ability of the pin assembly 120 to remain operably coupled to the circlip via the first and second orifices of the circlip. In some embodiments, such as the ones depicted in FIGS. 2 and 4, the first and second pins (122, 124) may each include a high friction surface 130 disposed thereon. The high friction surface 130 may be disposed over a portion of, or all of, the first and second pins (122, 124). In some embodiments, the high friction surface 130 may be disposed on the curved surface of the first and second pins (122, 124) on the portion of the first and second pins (122, 124) that extends out of the top and bottom jaws (106, 108), respectively. In this regard, responsive to the first and second pins (122, 124) being inserted into the first and second orifices of the circlip, the high friction surface 130 may engage with the first and second orifices of the circlip to improve the operable coupling of the hand tool 100 to the circlip, and improve the overall ability of the user of the hand tool 100 to place the circlip in the desired location.

In the embodiment shown in FIG. 2, the high friction surface 130 may include laser etching. In some cases, the high friction surface 130 could be embodied as any pattern of shapes that may be laser etched into the surface of the material of the first and second pins (122, 124). The various examples of laser etching patterns may increase a coefficient of friction of the first and second pins (122, 124) relative to the first and second orifices of the circlip. As shown in FIG. 2, the laser etched high friction surface 130 may include a repeating groove 132 pattern. In other words, the first and second pins (122, 124) of the pin assembly 120 may include a plurality of grooves 132 laser etched into the material where each groove 132 may extend around a circumference of each of the first and second pins (122, 124). Each groove 132 of the high friction surface 130 may be separated from the next consecutive groove 132 by a raised portion of material. Thus, the profile of the high friction surface, upon very close inspection, may resemble a series of grooves 132 and raised portions extending at least from the distal end of the first and second pins (122, 124) to a front end surface of the top and bottom jaws (106, 108), respectively.

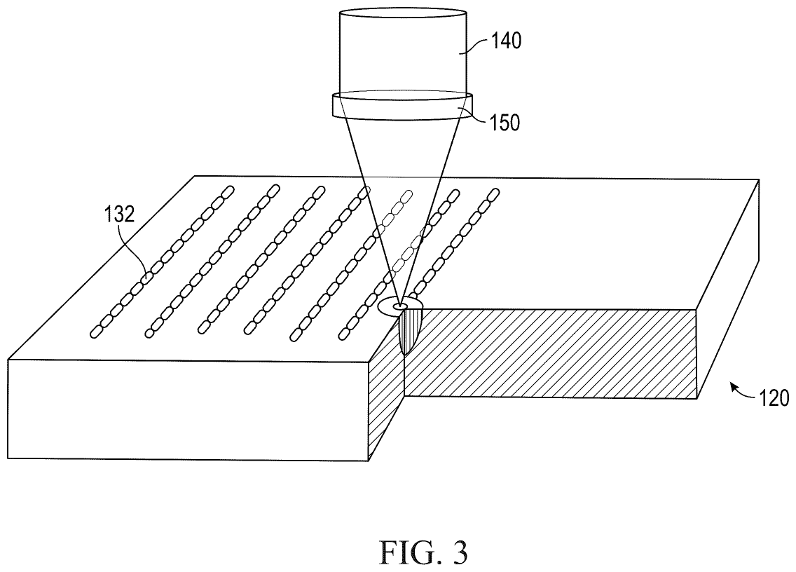

FIG. 3 illustrates a diagram of a laser etching process showing the formation of the high friction surface 130 according to an example embodiment. As shown in FIG. 4, the high friction surface 130 may be laser etched into the pin assembly 120. In this regard, the pin assembly 120 may be subjected to rapid pulses of a high powered laser 140 that may be focused into a very fine interaction region by a lens 150. In the laser etching process, the laser 140 may ablate the material at the surface of the pin assembly 120 at the interaction region. In other words, at the surface of the pin assembly 120, the laser 140 may heat the material of the pin assembly 120 rapidly, causing the material to liquefy and pool up very briefly before evaporating or sublimating and thereby forming a melt pool. The result after the material evaporates is the removal of material from the pin assembly 120 in organized patterns of a plurality of melt pools. The amount of material that is removed by each individual pulse from the laser 140 may be a function of the material properties of the particular material, the wavelength of the light from the laser 140, and the duration of the pulse. By controlling these factors, the high friction surface 130 may be formed to include precise patterns, such as the grooved pattern described above, etched onto the pin assembly 120. The grooves 132 may be etched by moving the laser 140 in straight lines relative to the surface of the pin assembly 120 in between pulses of the laser 140 such that the laser pulses ablating the surface of the pin assembly 120 create straight lines that extend around the circumference of each pin of the pin assembly 120. In other words, the laser 140 may ablate the surface of the pin assembly 120 with a singular pulse to form a first melt pool from the material of the pin assembly 120 accordingly. The laser 140 may then move around the first or second pin (122, 124) and away from the first melt pool, but only enough to reach an edge of the first melt pool. The laser 140 may then generate another pulse to ablate the material of the pin assembly 120 again, forming a second melt pool. The second melt pool may overlap with the first melt pool, such that there are no raised portions of material between consecutive melt pools. This process may then be repeated to ablate annular grooves 132 into the material of the pin assembly 120. It should be noted that the high friction surface 130 may not always be the grooved pattern described above. In some embodiments, the high friction surface 130 may include any number of other suitable patterns etched onto the pin assembly 120.

In the embodiment shown in FIG. 4, the high friction surface 130 may be formed by embedding by grains 160 into a base material 170. The grains 160 may be granular objects of any desirable type. For example, the grains 160 may be made of abrasive granules or granules of resin or plastic. In some cases, the abrasive granules may be made of silica, glass, ceramics, diamond dust, aluminum oxide, cubic zirconium, black zirconium, garnet, staurolite, emery, corundum, and/or the like. Granules made of resin or plastic may be selected to have any desirable hardness level. As such, some granules may actually be somewhat compressible or flexible, while other granules may be rigid and substantially incompressible. In some examples, the grains 160 (regardless of material used to form the grains 160) may be coated with a resin or plastic having desired characteristics. The grains 160 may be substantially all of similar sizes or diameters, or the grains 160 may have random or varying sizes/diameters. In still other examples, metallic grit (e.g., steel or copper) may be employed for the granules and thus, for example, the granules could even have magnetic properties in some cases.

In an example embodiment, the base material 170 may be an adhesive that can bind to the material used to form the pin assembly 120. The material used to form the pin assembly 120 may be metal, plastic, resin, and/or the like. However, in some cases, the base material 170 could be the same material used to form the pin assembly 120. Regardless of the material used to form the base material 170, in some examples the base material 170 may be applied and then the grains 160 may be embedded therein. In some cases, the grains 160 may be embedded by applying an adhesive or binder as the base material 170 and then placing the base material 170 in an electrostatic field to facilitate random deposition of the grains 160 thereon. The grains 160 may become embedded and may then be baked or heat cured into the base material 170. If desired and as mentioned above, a resin or other coating may then be applied over the grains 160 and the base material 170.

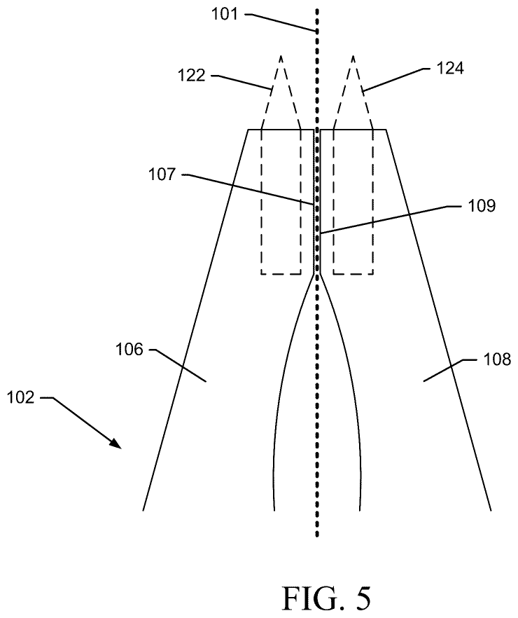

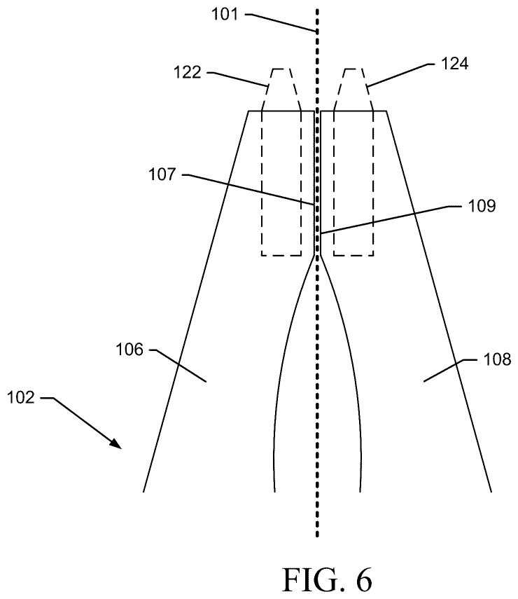

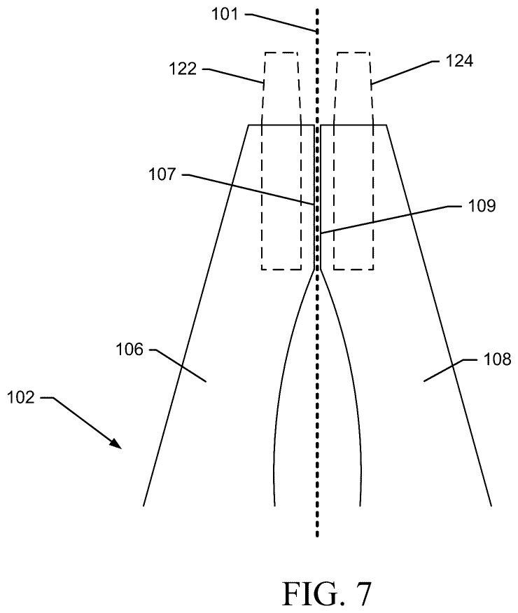

The pin assembly 120 depicted in FIGS. 2 and 4 may include first and second pins (122, 124) that may be substantially cylindrical in shape. The substantially cylindrical shape may allow for the high friction surface to be disposed around a length of the first and second pins (122, 124) on the curved surface of the cylinders. In this regard, the substantially cylindrical pins (122, 124) may operably couple to the orifices of the circlip by being inserted into the orifices of the circlip. Thus, the pin assembly 120 may directly interact with the circlip via the curved surface of the substantially cylindrical pins (122, 124) which may have the high friction surface 130 disposed thereon. In other words, the high friction surface 130 may be disposed along a length of the first and second pins (122, 124). FIGS. 5-9 depict various different embodiments of the pin assembly 120. In the embodiments depicted in FIGS. 5-9, the pin assembly 120 may be shaped in a variety of ways in order to maximize the ease and security of the operable coupling between the pin assembly 120 and the circlip. For example, the pins (122, 124) of the embodiment shown in FIG. 5 may be conical, the pins (122, 124) of the embodiment shown in FIG. 6 may be frustoconical, and the pins (122, 124) of the embodiment shown in FIG. 7 may be tapered. In this regard, the conical, frustoconical or tapered shaped may make it easier to insert the first and second pins (122, 124) into the orifices of the circlip. The farther that the pins (122, 124) are inserted into the circlip orifices, the more secure the operable coupling between the pin assembly 120 and the circlip is due to the angled nature of the embodiments shown in FIGS. 5-7. In all of FIGS. 5-7, the first and second pins (122, 124) may also include the high friction surface 130 disposed thereon. As described above, the high friction surface 130 may be disposed on the surface of the first and second pins (122, 124) that may directly interface with the circlip. Accordingly, the curved surface of the conical pins (122, 124), the frustoconical pins (122, 124) and the tapered pins (122, 124) may include the high friction surface 130. In the case of the frustoconical pins (122, 124) and the tapered pins (122, 124), the surfaces at the distal ends of the first and second pins (122, 124), respectively, may also include the high friction surface 130 disposed thereon in some embodiments. In other embodiments, the surfaces at the distal ends of the first and second pins (122, 124), respectively, may not include the high friction surface 130 disposed thereon.

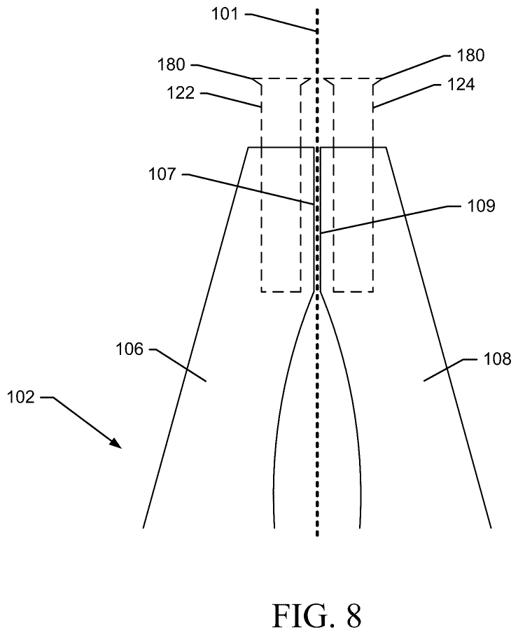

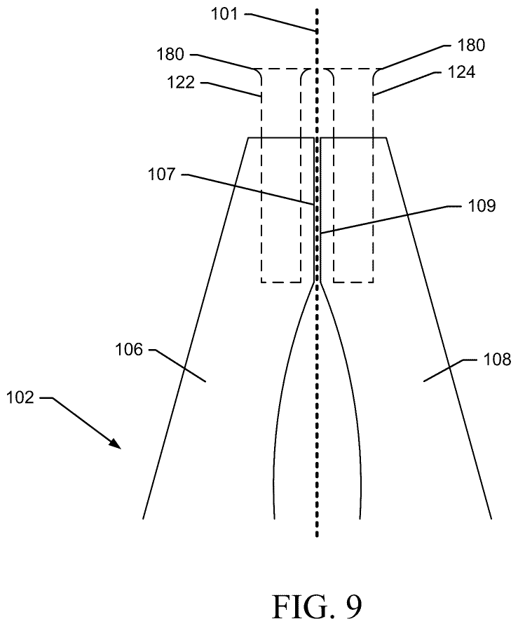

In some embodiments, such as the ones depicted in FIGS. 8 and 9, the pin assembly 120 may include a circlip retention lip 180 disposed at a distal end of the first and second pins (122, 124). The circlip retention lip 180 may increase the cross sectional area of the first and second pins (122, 124) so that the pin assembly 120 is more likely to remain operably coupled to the circlip when the hand tool 100 is in use. In this regard, as shown in FIG. 8, the circlip retention lip 180 may angularly extend from the distal end of the first and second pins (122, 124) such that the distal end of the first and second pins (122, 124) appears to have an inverted frustoconical shape that makes the first and second pins (122, 124) wider at the distal end thereof. Similarly, as shown by the embodiment depicted in FIG. 9, the pin assembly 120 may also include a circlip retention lip 180 that is flared rather than angular. In this regard, the flared circlip retention lip 180 may add a radius of curvature for the angle formed between the length of the first and second pins (122, 124) and the end surface of the first and second pins (122, 124).

Some example embodiments may provide for a hand tool. The hand tool may include a head section which may include a top jaw and a bottom jaw, a handle section which may include a top handle and a bottom handle, a joint assembly which may operably couple the head section to the handle section, and a pin assembly which may include a first pin disposed at a distal end of the top jaw and a second pin disposed at a distal end of the bottom jaw. A high friction surface may be disposed over at least a portion of the first and second pins.

The hand tool of some embodiments may include additional, optional features, and/or the features described above may be modified or augmented. Some examples of modifications, optional features and augmentations are described below. It should be appreciated that the modifications, optional features and augmentations listed below may each be added alone, or they may be added cumulatively in any desirable combination. For example, in some embodiments, the high friction surface may include laser etching. In some cases, the high friction surface may include a parallel circle pattern which may include grooves and raised portions. In an example embodiment, the grooves may be consecutive melt pools formed by ablating material of a surface of the first and second pins with a laser. In some cases, consecutive grooves may be separated by the raised portions. In an example embodiment, the high friction surface may include grains embedded in a base material disposed on the first and second pins. In some cases, the first and second pins may be substantially cylindrical in shape. In an example embodiment, the high friction surface may be disposed on a curved surface of the substantially cylindrical shape of the first and second pins. In some cases, the first and second pins may be conical, frustoconical or tapered in shape. In an example embodiment, the high friction surface may be disposed along a length of the first and second pins. In some cases, the first and second pins may be flared or inverted frustoconical at a distal end of each pin. In an example embodiment, the hand tool may be a set of external circlip pliers. In some cases, the top jaw may move away from the bottom jaw responsive to the top handle moving towards the bottom handle. In an example embodiment, the hand tool may be a set of internal circlip pliers. In some cases, the top jaw may move towards the bottom jaw responsive to the top handle moving towards the bottom handle.

Some example embodiments may provide for a pin assembly for a hand tool. The pin assembly may include a first pin disposed at a distal end of a top jaw of the hand tool and a second pin disposed at a distal end of a bottom jaw of the hand tool. A high friction surface may be disposed over at least a portion of the first and second pins.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A hand tool comprising:
a head section including a top jaw and a bottom jaw;
a handle section including a top handle and a bottom handle;
a joint assembly operably coupling the head section to the handle section; and
a pin assembly having a first pin disposed at a distal end of the top jaw and a second pin disposed at a distal end of the bottom jaw,
wherein a high friction surface is disposed over at least a portion of the first and second pins.

2. The hand tool of claim 1, wherein the high friction surface comprises laser etching.

3. The hand tool of claim 2, wherein the high friction surface comprises a parallel circle pattern comprising grooves and raised portions.

4. The hand tool of claim 3, wherein the grooves are consecutive melt pools formed by ablating material of a surface of the first and second pins with a laser, and
wherein consecutive grooves are separated by the raised portions.

5. The hand tool of claim 1, wherein the high friction surface comprises grains embedded in a base material disposed on the first and second pins.

6. The hand tool of claim 1, wherein the first and second pins are substantially cylindrical.

7. The hand tool of claim 6, wherein the high friction surface is disposed on a curved surface of the cylinder.

8. The hand tool of claim 1, wherein the first and second pins are conical, frustoconical or tapered in shape.

9. The hand tool of claim 8, wherein the high friction surface is disposed along an exposed length of the first and second pins.

10. The hand tool of claim 1, wherein the first and second pins are flared or inverted frustoconical at a distal end of each pin.

11. The hand tool of claim 1, wherein the hand tool is a set of external circlip pliers,
wherein the top jaw moves away from the bottom jaw responsive to the top handle moving towards the bottom handle.

12. The hand tool of claim 1, wherein the hand tool is a set of internal circlip pliers,
wherein the top jaw moves towards the bottom jaw responsive to the top handle moving towards the bottom handle.

13. A pin assembly for a hand tool, the pin assembly comprising:
a first pin disposed at a distal end of a top jaw of the hand tool;
a second pin disposed at a distal end of a bottom jaw of the hand tool; and
a high friction surface disposed over at least a portion of the first and second pins.

14. The pin assembly of claim 13, wherein the high friction surface comprises laser etching.

15. The pin assembly of claim 14, wherein the high friction surface comprises a parallel circle pattern comprising grooves and raised portions.

16. The pin assembly of claim 15, wherein the grooves are consecutive melt pools formed by ablating material of a surface of the first and second pins with a laser, and
wherein consecutive grooves are separated by the raised portions.

17. The pin assembly of claim 13, wherein the high friction surface comprises grains embedded in a base material disposed on the first and second pins.

18. The pin assembly of claim 13, wherein the first and second pins are substantially cylindrical in shape, and
wherein the high friction surface is disposed on a curved surface of the cylinder.

19. The pin assembly of claim 13, wherein the first and second pins are conical, frustoconical or tapered in shape, and
wherein the high friction surface is disposed along a length of the first and second pins.

20. The pin assembly of claim 13, wherein the first and second pins are flared or inverted frustoconical at a distal end of each pin.
